(19) United States
(12) Patent Application Publication
(10) Pub. No.: US 2018/0263858 A1
(43) Pub. Date: Sep. 20, 2018

(54) Teething Glove and Mitt

(71) Applicant: Frank Williams, Jamaica Queens, NY (US)

(72) Inventor: Frank Williams, Jamaica Queens, NY (US)

(21) Appl. No.: 15/925,692

(22) Filed: Mar. 19, 2018

Related U.S. Application Data
(60) Provisional application No. 62/473,167, filed on Mar. 17, 2017.

(51) Int. Cl. A61J 17/02; A41D 19/01; A41D 19/00; A41F 1/06

(52) U.S. Cl. CPC A61J 17/02; A41D 19/01; A63H 5/00; A41F 1/06; A41D 19/002; A41D 19/0065

(57) ABSTRACT

A teething glove or mitt comprising a covering for a hand comprising comprises a textured surface in the form of raised bumps distributed on the surface of the glove or mitt.

### CLAIM OF PRIORITY

This patent application claims priority under 35 USC 119 (e) (1) from U.S. Provisional Patent Application Ser. No. 62/473,167 filed Mar. 17, 2017, of common inventorship herewith entitled, “Teething Glove and Mitt,” which is incorporated herein by reference as though the same were set forth in its entirety.

### FIELD OF THE INVENTION

The present invention pertains to the field of teething gloves and mitts, and more specifically to the field of teething gloves and mitts configured in the form of a lightweight and flexible wearable glove or mitt to be worn on the child's hand or hands.

### BACKGROUND OF THE INVENTION

The present invention is a Although every child is different, the average infant cuts his or her first tooth during their seventh month, although the first teeth can arrive as early as three months, as late as a year, or in rare cases even earlier or later. In total, a child cuts twenty primary teeth, over the course of several months. In order to alleviate the pain caused by teething, most parents employ teething rings as a means of soothing their child as they endure this painful process. Teething rings are soft, fluid filled objects designed to massage the infant's swollen and sore gums. Although teething rings can provide temporary relief of the pain caused by teething, use of one is not without drawbacks. Specifically, most teething rings are circular shaped objects which can be difficult for the child to comfortably insert into their mouth. Awkward in shape, the traditional, ring-style teething ring, does little good if the child cannot position it over his or her gums. Because of this, many teething babies and toddlers actually prefer to suck on their own hands and fingers. Providing gentle counter-pressure to the emerging tooth, many parents find that allowing a child to gently suck on their own fist actually provides more comfort to the irritated gums, than does a teething ring. Unfortunately however, should the child put their fingers in their mouth after crawling about the floor or playing with their favorite toys or a family pet, the result can be that they transfer a myriad of germs and bacteria lingering on their hands, directly into their mouth

The prior art has put forth several designs for teething gloves and mitts. Among these are:

US Patent Application No. 2006/0004412 to Ed Gilbert describes a mitten with a teething surface (element) covering the hands and giving a more natural way of comfort other than a ring or foreign object. Teething products not attached to the infant hands are susceptible to failing onto different surfaces and collecting contaminations, in turn, the teething product will have to be continuously cleaned. A teething mitten can also deter finger or thumb sucking in the future. The teething mitten may consist of a rubberized surface; either smooth or textured, with a firm or gelatinous consistency.

US Patent Application No. 2012/0016416 to Lucille Frazier describes a teething glove including a body member having upper and lower ends. A wrist attachment member is connected to the lower end of the body member and includes an elongate configuration that is extendable about a user's wrist and length adjustable. A pair of finger sleeves is attached to the upper end of the body member and extends away therefrom, each finger sleeve having a generally tubular configuration defining an open proximal end and a closed distal end.

US Patent Application No. 2005/0222621 to Duwelius et al describes an article of manufacture for teething infants to bite having a teething device constructed to affix to a mitten, a mitten constructed to fit over an infant's hand, a structure for securing an infant's hand within the mitten, and a way of securing the teething device to the mitten. The teething mitten secures to an infant's hand allowing infant to provide teething relief to him/herself while simultaneously preventing gagging, need for constant parental assistance, and dropping of teething mitten. A preferred embodiment includes the teething device construction to provide a moisture barrier to prevent moisture from penetrating the mitten.

US Patent Application No. 2009/101438 to Kristen L. Perry describes a teething device including a covering member for covering at least one of a hand of an infant, a wrist of an infant, and a combination thereof. Such covering member is manufactured from a first predetermined material and has a first predetermined size and a first predetermined shape. A securing mechanism is operably connected to such covering member at a predetermined location thereon for releasably securing such covering member to at least one of such infant's hand, such infant's wrist, and a combination thereof. At least one teething member is operably connected to at least a predetermined portion of such covering member. Such at least one teething member is manufactured from a second predetermined material and has a second predetermined size and a second predetermined shape.

None of these prior art references describe the present invention.

### SUMMARY OF THE INVENTION

It is an object of the present invention to provide a teething glove configured in the form of a lightweight and flexible wearable glove to be worn on the child's hand or hands.

It is an object of the present invention to provide a teething mitt configured in the form of a lightweight and flexible wearable mitt to be worn on the child's hand or hands.

It is a further object of the present invention to provide a teething mitt or glove sized to fit the hand of a caregiver.

### BRIEF DESCRIPTION OF THE DRAWINGS

FIG. 1 is a perspective view illustrating a teething glove, constructed in accordance with the present invention.

FIG. 2 is a close-up view of a section of the glove showing a hemispherical raised bump.

FIG. 3 is a perspective view illustrating a teething mitt, constructed in accordance with the present invention.

FIG. 4 is a perspective view illustrating a teething glove, constructed in accordance with the present invention, showing a hook and loop securing wrist strap.

FIG. 5 is a perspective view illustrating a teething mitt, constructed in accordance with the present invention, showing a concealed pocket for receiving an object such as a “squeaky toy.”

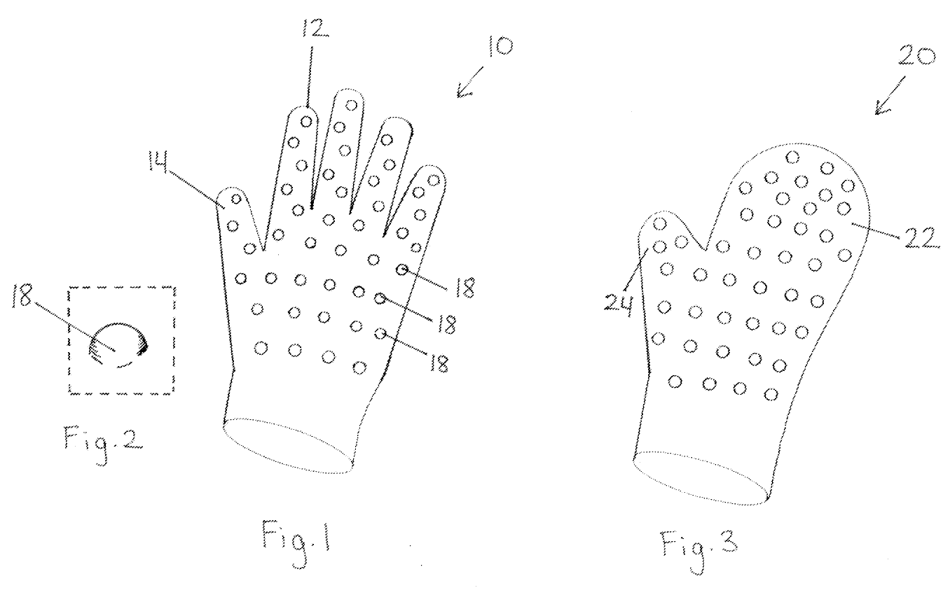

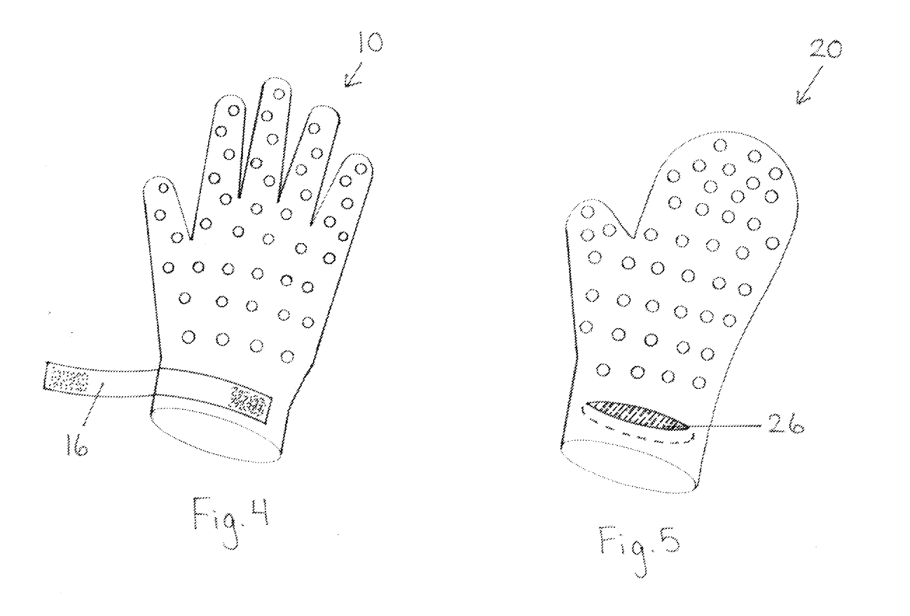

### DETAILED DESCRIPTION OF THE INVENTION

Please refer to the drawings.

The Teething Glove and Teething Mitt offers users a teether providing a practical improvement to the design of infant teethers which enables infant children to comfortably hold the teether within their mouth, unassisted. The Teething Glove and Mitt is a line of specially designed teethers, configured in the form of a wearable glove 10 or mitt 20 to be easily slipped over the infant's hand and designed specifically to alleviate the pain caused by teething. Sold individually or in sets of two for both the left and right hand, the Teething Glove and Mitt is produced in a one-size-fits-all standard. Either version of the unit (glove or mitt) measures approximately between 2 to 3 inches in length, inches in width and approximate one to 2 inches in total depth.

An alternative embodiment provides the glove or mitt to be sized appropriately for the hand of a parent or caregiver.

The glove version 10 of this product features a five finger design for covering a human hand comprising a separate sheath for each finger, with individual sections for the thumb 14 and four fingers 12, while the mitt version 20 features a thumb section 24 and a single sheathe 22 that accommodates the four remaining digits. Either version of this teethes encompasses the child's hand completely and extends slightly beyond the child's fingers. The interior of the Teething Glove and Mitt can be manufactured primarily of cushiony soft cotton or comparable material that is gentle on the baby's skin.

In an embodiment, to prevent the glove or mitt from sliding off during wear, a simple, self-adhesive hook and loop fastener 16 is positioned at the base of each glove for use in adjusting and securing the unit for a comfortable, customized fit around the wearer's wrist. In an embodiment, a concealed pocket 26 is configured to receive an object, such as an entertaining “squeaky toy” is incorporated into the wrist portion of the glove or mitt. The most notable aspect of the Teething Glove and Mitt however is found in the waterproof “teether”0 material which coats the exterior of each. A nontoxic and breathable rubber or comparable synthetic, this washable material features a textured surface to provide soothing relief to aching gums. As such, a series of raised bumps 18 or nodules are distributed upon the surface of the top and underside of the glove or mitt to provide a gentle surface on which the child can bite down to alleviate teething discomfort.

In an alternative embodiment, the teethers can be offered in versions coated with a delicious flavoring based on popular baby foods such as fruits or vegetables.

The Teething Glove and Teething Mitts produced in a myriad of charming colors to appeal to children. Because the safety and well-being of the infant is of the utmost importance, the Teething Glove and Mitt is manufactured in accordance to the stringent guidelines for children's accessories as set forth by the Juvenile Products Manufactures Association (JPMA).

Use of the Teething Glove and Mitt is very simple and straight forward. First, the parent or caregiver slides the open end of the appropriate right or left Teething Glove or Mitt over the infant's hand, securing the cushiony soft glove or mitt in place around the child's wrist by means of the integrated hook and loop strap. After making any necessary adjustments for a comfortable fit, this process is repeated with the remaining glove. Next, the parent allows the child to insert their gloved or mitted hand within their mouth, enabling the child to gently “chew” on the actual teething surfaces as desired. For extra relief, the Teething Glove and Mitt can be chilled in the refrigerator before being given to the child, thereby providing cold therapy to the sore gums.

The Teething Glove and Mitt is an innovative product concept offering users many significant benefits and advantages. Foremost, this cleverly designed line of infant teethers offers soothing comfort to any child as they cut their first teeth. A cleverly designed line of wearable gloves and mitts boasting integrated teethers incorporated into their design, the Teething Glove and Mitt provides steadfast and gentle counter-pressure to emerging teeth. Massaging the gums with a soft, yet firm textured nontoxic rubber material, the Teething Glove and Mitt provides a practical way in which to alleviate the pain caused by teething, both in the front of the mouth, as well as in the hard-to-reach area in the back of the gums. Offering an effective treatment for teething pain, use of the Teething Glove and Mitt can also effectively prevent the irritability and restlessness that is often associated with the teething process. Perhaps most importantly, the unique, glove and/or mitt design of the Teething Glove and Mitt enables infants and toddlers to easily hold and utilize the unit. Slipped over the hand and inserted directly into the mouth, the Teething Glove and Mitt is utilized in a comfortable and relaxed manner. A practical alternative to oversized circular rings which can be difficult for the infant to hold or properly position within their mouth, the Teething Glove and Mitt is easily handled by babies and toddlers alike. Sparing the parent or caregiver the task of continuously holding onto an infant's teether for them, use of the Teething Glove and Mitt enables the parent to focus their attention to other aspects of their child's care. In addition, the washable Teething Glove and Mitt provides a sanitary alternative to allowing the child to suck on their own hands and fingers. Protecting the child from germs and bacteria that may be lingering on the hands, the Teething Glove and Mitt are beneficial products which protect the health and well-being of the infant. Easily refrigerated, the Teething Glove and Mitt can also be utilized to administer cold therapy, thus providing instant relief to bleeding and swollen gums. Manufactured in accordance to JPMA standards, parents and caregivers can rest assured that they are using a product that was made with the safety and care for their baby in mind.

Innovative and practical, the Teething Glove and Mitt offers users a simple means of alleviating the pain caused by teething. Providing gentle, soothing relief to swollen and sore gums, this cleverly designed product proves an invaluable accessory for any parent or caregiver of a small child. Affordably priced, the Teething Glove and Mitt will be well received by parents and professional caregivers, a very sizable market potential.

Although this invention has been described with respect to specific embodiments, it is not intended to be limited thereto and various modifications which will become apparent to the person of ordinary skill in the art are intended to fail within the spirit and scope of the invention as described herein taken in conjunction with the accompanying drawings and the appended claims.

1. A teething glove comprising a covering for a hand comprising a separate sheath for each finger, wherein the glove further comprises a textured surface in the form of raised bumps distributed on the surface of the glove.

2. The teething glove of claim 1, wherein the glove is made of a washable, nontoxic and breathable rubber or comparable synthetic material.

3. The teething glove of claim 2, further comprising a hook and loop fastener positioned at the base of the glove for use in adjusting and securing the unit for comfortable, customized fit around the wearer's wrist.

4. The teething glove of claim 2, further comprising a concealed pocket configured to receive an object, wherein the pocket is incorporated into the wrist portion of the glove.

5. The teething glove of claim 2, wherein the glove is coated with a delicious flavoring based on popular baby foods such as fruits or vegetables.

5. The teething glove of claim 2, wherein the glove is produced in a myriad of charming colors to appeal to children.

7. The teething glove of claim 2, wherein the glove is capable of being chilled in the refrigerator before use.

8. The teething glove of claim 2, sized appropriately for use by a human infant.

9. The teething glove of claim 2, sized appropriately for use by a human adult.

10. The teething glove of claim 2, further comprising a lining in the interior of the glove comprising a cushiony soft cotton or comparable material.

11. A teething mitt comprising a covering for a hand comprising a separate sheath for covering a thumb and a single sheath for covering the four remaining fingers, wherein the mitt further comprises a textured surface in the form of raised bumps distributed on the surface of the mitt.

12. The teething mitt of claim 11, wherein the mitt is made of a washable, nontoxic and breathable rubber or comparable synthetic material.

13. The teething mitt of claim 12, further comprising a hook and loop fastener positioned at the base of the mitt for use in adjusting and securing the unit for a comfortable customized fit around the wearer's wrist.

14. The teething mitt of claim 12, further comprising a concealed pocket configured to receive an object, wherein the pocket is incorporated into the wrist portion of the mitt.

15. The teething mitt of claim 12, wherein the mitt is coated with a delicious flavoring based on popular baby foods such as fruits or vegetables.

16. The teething mitt of claim 12, wherein the mitt is produced in a myriad of charming colors to appeal to children.

17. The teething mitt of claim 2, wherein the mitt is capable of being chilled in the refrigerator before use.

18. The teething mitt of claim 12, sized appropriately for use by a human infant.

19. The teething mitt of claim 2, sized appropriately for use by a human adult.

20. The teething mitt of claim 12, further comprising a lining in the interior of the mitt comprising a cushiony soft cotton or comparable material.
